(19) United States
(12) Patent Application Publication
(10) Pub. No.: US 2026/0009670 A1
(43) Pub. Date: Jan. 8, 2026

(54) TRIMMABLE FLUID LEVEL SENSING STRIP

(71) Applicant: SETRA SYSTEMS, INC., Boxborough, MA (US)

(72) Inventors: Nathan H. KULAK, Collinsville, CT (US); Michael TETREAULT, Weatogue, CT (US)

(21) Appl. No.: 18/763,831

(22) Filed: Jul. 3, 2024

(51) Int. Cl. G01F 23/263

(52) U.S. Cl. CPC G01F 23/265

(57) ABSTRACT

Systems, apparatuses, and methods provide for a fluid level sensor including a flexible substrate. A continuous sensor plate is coupled to the flexible substrate. A continuous ground plate is coupled to the flexible substrate and positioned parallel to the continuous sensor plate. A sensor array is positioned parallel to the continuous sensor plate, where the sensor array comprises three or more capacitive plates in a linear alignment. A component array is positioned parallel to the continuous sensor plate, where the component array includes three or more components in a linear alignment, where each of the components corresponds with one of the capacitive plates.

### FIELD

The instant disclosure relates generally to systems, apparatuses, and methods for a fluid level sensing strip. In particular, embodiments of the instant disclosure relate to systems, apparatuses, and methods for a trimmable fluid level sensing strip.

### BACKGROUND

Capacitive based sensing is a common technical modality for the detection of liquids in a container (e.g., tanks, pipes, or other vessels). Capacitive based sensors typically monitor a sensor field between a fill level sensor and a reference electrode. The fill level of fluid in a container affects this sensor field due to a difference between a dielectric constant of the fluid in the container and a dielectric constant of the gas in the container (i.e., in the space above the fluid and still within the container). As the fluid level changes, the shifting ratios of the dielectric constant of the fluid and the dielectric constant of the gas likewise changes the capacitance value established between the fill level sensor and the reference electrode.

These capacitive based sensors come in both continuous and single point varieties. Continuous capacitive sensors typically require sensing range (i.e., a length of the sensor) to be either factory set as build to order product or, in the case of sensors external to the tank, be stacked together in a coupling process known as “daisy chaining.”

While a daisy chaining implementation operates acceptably for its intended purpose, various improvements thereto would be a welcome addition in the art.

### SUMMARY

Advantageously, some implementations discussed herein provide a single capacitive strip that can either be used at its maximum sense range (e.g., at the full length provided) or be cut with scissors or other suitable implement to various lengths suitable to the end user's needs.

As will be described in greater detail below, in some implementations discussed herein, systems, apparatuses, and methods provide for a fluid level sensor including a flexible substrate. A continuous sensor plate is coupled to the flexible substrate. A continuous ground plate is coupled to the flexible substrate and positioned parallel to the continuous sensor plate. A sensor array is positioned parallel to the continuous sensor plate, where the sensor array comprises three or more capacitive plates in a linear alignment. A component array is positioned parallel to the continuous sensor plate, where the component array includes three or more components in a linear alignment, where each of the components corresponds with one of the capacitive plates.

In one example, a method includes trimming a fluid level sensor into a removed portion and a remaining trimmed fluid level sensor. In such an example, the trimming occurs between a first pair of capacitive plates and components located on the removed portion and a second pair of capacitive plates and components located on the remaining trimmed fluid level sensor. A length of the trimmed fluid level sensor is then determined based on a measured parameter (e.g., resistance) of the components remaining in the trimmed fluid level sensor.

In another example, a fluid level sensor, includes a substrate. A continuous sensor plate is coupled to the substrate. A continuous ground plate is coupled to the substrate and positioned parallel to the continuous sensor plate. A sensor array is positioned parallel to the continuous sensor plate, where the sensor array comprises three or more capacitive plates in a linear alignment. A component array is positioned parallel to the continuous sensor plate, wherein the component array comprises three or more components in a linear alignment, wherein each of the components corresponds with one of the capacitive plates.

This Summary is provided to introduce a selection of concepts in a simplified form that are further described below in the Detailed Description. The foregoing Summary, as well as the following Detailed Description of certain implementations, will be better understood when read in conjunction with the appended drawings. This Summary is not intended to identify key features or essential features of the claimed subject matter, nor is it intended to be used as an aid in determining the scope of the claimed subject matter.

### BRIEF DESCRIPTION OF THE DRAWINGS

The foregoing and other features and advantages will be discussed in detail in the following non-limiting description of specific embodiments in connection with the accompanying drawings, in which:

FIG. 1 illustrates a front view of a flexible housing for a fluid level sensor according to an example of the instant disclosure;

FIG. 2 illustrates a front view of another fluid level sensor according to an example of the instant disclosure;

FIG. 3 illustrates a cross sectional side view of the fluid level sensor of FIG. 2 according to an example of the instant disclosure;

FIG. 4 illustrates a schematic view of a data processor according to an example of the instant disclosure;

FIG. 5 is an illustration of a flowchart of an example method for fluid level sensing according to an example of the instant disclosure;

FIG. 6 is an illustration of a flowchart of another example method for fluid level sensing according to an example of the instant disclosure;

FIG. 7 is a block diagram illustrating a computer program product according to an example of the instant disclosure;

FIG. 8 is a block diagram illustrating an example fluid delivery apparatus according to an example of the instant disclosure; and

FIG. 9 is a block diagram illustrating a hardware apparatus including a semiconductor package according to an example of the instant disclosure.

### DETAILED DESCRIPTION OF THE PRESENT EMBODIMENTS

As will be described in greater detail below, in some implementations discussed herein, a fluid level sensor includes a rubberized strip that is used to encase a printed circuit board (PCB) (e.g., a flexible PCB). Various sensor plates (e.g., copper sensor plates) that act as the capacitive elements are printed on the flexible PCB. In some examples, the flexible PCB will also include a capacitance to digital converter, shielding, and an interconnect for use with an appropriate input/output (I/O) module. As used herein, a “plate” refers to an electrically conductive material.

In some embodiments, the sensor array comprises a sense conductor (referred to herein as CL or C-LEVEL). CL is a non-shielded conductor that runs the entire length of the sensor length and is responsible for reporting continuous change in capacitance with changing media level.

In some embodiments, the sensor array comprises an environmental reference conductor (referred to herein as RE). RE is a shielded conductor that runs only at the top of the sensor array where sensor is trimmed and is responsible for compensating changes to the sensor environment e.g., surrounding air temperature etc.

In some embodiments, the sensor array comprises a liquid reference conductor (referred to herein as RL). RL is a shielded conductor located at the very bottom of sensor. RL is responsible for changes in the dielectric of the media. In this manner, for example, two identical sensors submerged in two different media types would show the same output for a mutual level because differences in dielectric constant (or relative permittivity) are accounted for by virtue of values measured by RL. Or, as another example, one sensor in a media would not report significant level change due to changing temperature of the media.

In some embodiments, the sensor array comprises a ground conductor (referred to herein as GND).

In some embodiments, some, or all the previously described sensors (including associated shields) may be printed onto a suitable flexible substrate. The responsibility of each sensor remains the same as in previously described embodiments, the printed flexible construction enables complete non-contact sensing through application of a suitable adhesive necessary to join the flexible embodiment to the exterior of the vessel of interest. In this embodiment an additional shield layer is utilized on top of the non-sensing side of the flexible construction to provide immunity to erroneous signals originating from outside the vessel of interest.

Advantageously, some implementations discussed herein include the addition of an extra sensor array and an accompanying series of resistors (e.g., or other componentry). For example, the extra sensor array has a series of capacitive plates common to a single channel of the capacitance to digital converter (e.g., where a series of potential dry reference sensor plates share a common channel, while a wet reference sensor plate has its own channel). Cutting the fluid level sensor in strategic locations would result in the trimmed fluid level sensor having a reduced number of capacitive plates. Such a series of capacitive plates has the bottom plate set as a wet reference and any of the other capacitive plate capable of being set as a dry reference, depending on the desired length of the trimmed fluid level sensor.

Meanwhile the accompanying series of resistors would be used by an I/O module for determination of the length of the fluid level sensor. Cutting the fluid level sensor in strategic locations would result in the fluid level sensor identifying the new “max” level for the trimmed fluid level sensor. For example, cutting the fluid level sensor in strategic locations would effectively eliminate resistance from the series of resistors thus identifying the trimmed fluid level sensor as having a new length to the I/O module. For example, each series resistor would correspond with one of the additional capacitive plates. The length possibilities will not be infinite, rather they will be as numerous and variable as spacing between resistors and capacitive plates allow. In some examples, the rubberized strip will indicate where cuts can be safely made without damage to the underlying circuitry. Lastly the end cut would be sealed from exposure to the environment via a provided bondable end, for example.

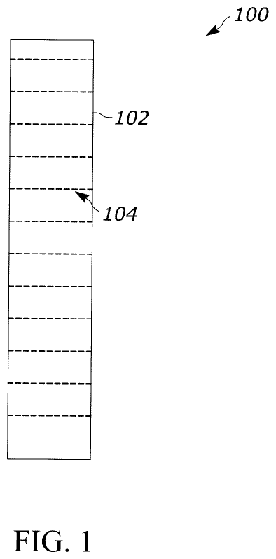

FIG. 1 illustrates a front view of a flexible housing 102 for a fluid level sensor 100 according to an example of the instant disclosure. As will be discussed in greater detail below, the fluid level sensor 100 is adapted to be trimmed into a removed portion and a remaining trimmed fluid level sensor.

In some implementations, the flexible housing 102 encompassing a flexible substrate.

In some examples, at least one, and preferably a plurality of trimmable indicators 104 is located on the flexible housing 102. Such trimmable indicators 104 could include any perceptible indicia including, but not limited to, dashes, dots, perforations, the like, and/or combinations thereof. As will be discussed in greater detail below, each trimmable indicator 104 is located between a first pair of the capacitive plates and the resistors (e.g., or other componentry) and a second pair of the capacitive plates and the resistors.

In operation, the fluid level sensor 100 is trimmed into a removed portion and a remaining trimmed fluid level sensor. In such an example, the trimming occurs between a first pair of capacitive plates and resistors (e.g., or other componentry) located on the removed portion and a second pair of capacitive plates and resistors located on the remaining trimmed fluid level sensor. As illustrated, the trimming occurs at an indicator 104 located on the flexible housing 102. Additionally, the fluid level sensor 100 established by the remaining portion may be sealed at the location where the fluid level sensor 100 was trimmed.

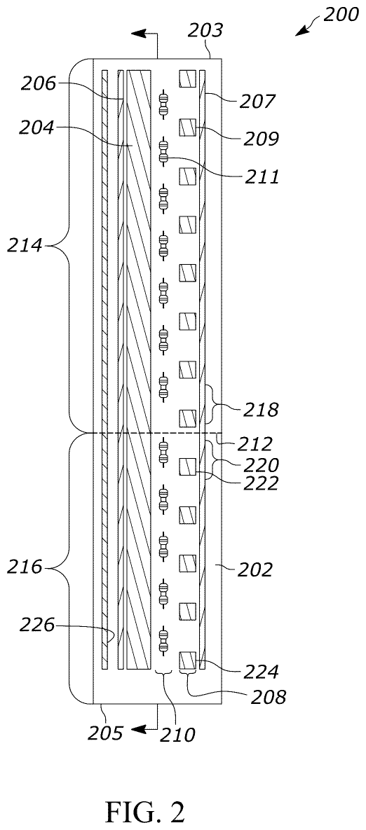

FIG. 2 illustrates a front view of fluid level sensor 200 according to an example of the instant disclosure. As illustrated, the fluid level sensor 200 includes a continuous sensor plate 204 coupled to a flexible substrate 202. In some implementations, the continuous sensor plate 204 has an elongated linear shape running from an upper end 203 of the flexible substrate 202 to a lower end of the flexible substrate 205. The continuous sensor plate is composed of copper, another flexible conductive substance, and/or combinations thereof.

A continuous ground plate 206 is coupled to the flexible substrate 202 and positioned parallel to the continuous sensor plate 204. The continuous ground plate 206 has an elongated linear shape running from the upper end 203 of the flexible substrate 202 to the lower end 205 of the flexible substrate 202. The continuous ground plate 206 is composed of copper, another flexible conductive substance, and/or combinations thereof.

In some implementations, a sensor array 208 is positioned parallel to the continuous sensor plate 204. In an embodiment, the sensor array 208 is coupled to the flexible substrate 202, though this is not necessarily a requirement. The sensor array 208 comprises three or more capacitive plates 209 in a linear alignment. The capacitive plates 209 are composed of copper, another flexible conductive substance, and/or combinations thereof. In some examples, each of the capacitive plates 209 has a dedicated trace (not illustrated).

A continuous ground plate 207 is coupled to the flexible substrate 202 and positioned parallel to the sensor array 208. The continuous ground plate 207 has an elongated linear shape running from the upper end 203 of the flexible substrate 202 to the lower end 205 of the flexible substrate 202. The continuous ground plate 207 is composed of copper, another flexible conductive substance, and/or combinations thereof.

In some examples, a component array 210 is adjacent to the sensor array 208 and positioned parallel to the continuous sensor plate 204. In an embodiment, the component array 210 is coupled to the flexible substrate 202, though this is not a requirement. The component array 210 comprises three or more components 211 in a linear alignment. In an embodiment each of the components may comprise a discrete component. Each of the components 210 corresponds with one of the capacitive plates 209. In the illustrated embodiment, each of the components 210 comprise a resistor or a capacitor. In some examples, the componentry comprises discrete componentry or integrated componentry.

As discussed above, wherein the fluid level sensor 200 is adapted to be trimmed into a removed portion 214 and a remaining trimmed fluid level sensor 216 at any number of locations. The trimmable location 212 (e.g., as would correspond to a trimmable indicator, see FIG. 1) is located between a first pair of the capacitive plates and the components 218 and a second pair of the capacitive plates and the components 220. When trimmed, a top plate of the capacitive plates 209 comprises a dry reference sensor 222 (depending on the location of the trim) and a bottom plate of the capacitive plates 209 comprises a wet reference sensor 224. As discussed above, in some examples, each of the capacitive plates 209 has a dedicated trace (not illustrated). Accordingly, all remaining dedicated traces except for the assigned traces for the dry reference sensor 222 and the wet reference sensor 224 would need to be severed so that the top plate of the capacitive plates 209 is the only dry reference that data is obtained from. In one example, severance will be accomplished by providing surface mount jumpers (not illustrated) and/or the like that can be cut on a back side of the fluid level sensor 200.

In some implementations, the fluid level sensor 200 includes a continuous compensating reference plate 226 coupled to the flexible substrate 202 and positioned parallel to the continuous sensor plate 204. The continuous compensating reference plate 226 provides an additional means (e.g., in addition to the components 211) of identifying sensor length upon trimming. In such an implementation, the base capacitance value of the compensating reference plate 226 will drop as portions of the fluid level sensor 200 are removed, and variations in the base capacitance value of the compensating reference plate 226 will be utilized to estimate the remaining length of the fluid level sensor 200 when trimmed.

In some examples, the flexible substrate is a flexible printed circuit board. For example, such a flexible substrate is composed of polyimide, polyamide, polyester, fluoropolymers, liquid crystal polymer, the like, and/or combinations thereof.

In operation, the fluid level sensor 200 senses a fluid-based capacitance value via the continuous sensor plate 204. A wet reference capacitance value is determined via the wet reference sensor 224 and a dry reference capacitance value is determined via the dry reference sensor 222. An output fluid level is determined based on the sensed fluid capacitance value, the wet reference capacitance value, and the dry reference capacitance value. For example, the output fluid level may be determined by the following formula: Level=(CO−CL)/(RL−RE), where CO is a sensed fluid capacitance value when there is no fluid present, CL is the sensed fluid capacitance value, RL is the wet reference capacitance value, and RE is the dry reference capacitance value. Additionally, in some implementations, a capacitance value from the continuous compensating reference plate 226 is utilized to identify sensor length upon trimming.

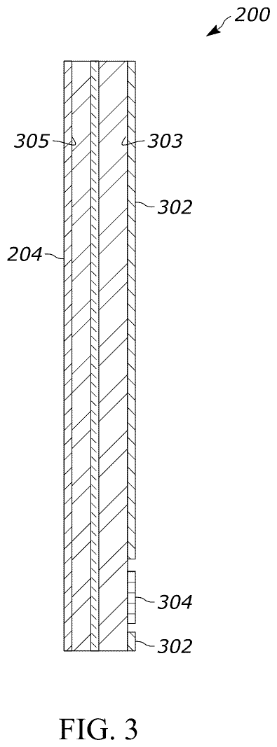

FIG. 3 depicts a cross sectional view of the fluid level sensor 200 embodiment of the present invention as it would be applied to a flexible substrate. As illustrated, fluid level sensor 200 is implemented as a multi-layer PCB including an additional exterior shielding layer 302 positioned about a capacitance to digital converter 304.

In some implementations, the fluid level sensor 200 includes the exterior shielding layer 302 which is located on an outer surface 303 of the substrate 202 that is opposite an inner surface 305 of the substrate 202 where the continuous sensor plate 204 is located. In some examples, the exterior shielding layer 302 is composed of copper, another flexible conductive substance, and/or combinations thereof.

In some examples, the fluid level sensor 200 includes the capacitance to digital converter 304 used, as known in the art, to convert measured capacitances to digitally represented values that may be processed by a suitable processing device. In such an example, the capacitance to digital converter 304 is located on the outer surface 303 of the substrate 202 in a gap formed in the exterior shielding layer 302. It is noted that electrical connections between the various conductors of the fluid level sensor 200 and the capacitance to digital converter 304, or electrical connections between the capacitance to digital converter 304 and a data processor, are not shown for ease of illustration. Techniques for the establishment of such connections are well known to those skilled in the art.

In operation, the continuous sensor plate, the wet reference capacitive plate, and the dry reference capacitive plate are shielded from capacitive interference via the exterior shielding layer 302. Such shielding via the exterior shielding layer 302 prevents interference with a user (e.g., a user's hand).

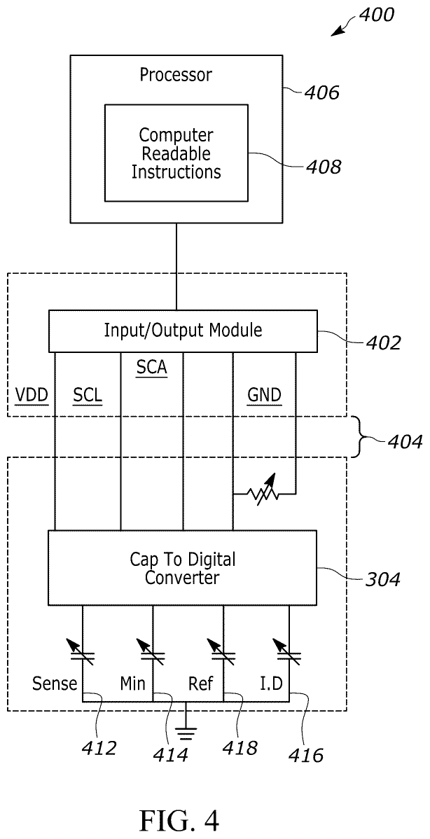

FIG. 4 illustrates a schematic view of a data processor 400 according to an example of the instant disclosure. As illustrated data processor 400 includes a capacitance to digital converter 304 coupled to an input/output (I/O) module 402 via an interconnect 404. Data from the I/O module 402 may be processed by computer readable instructions 408 associated with a processor 406. In some examples computer readable instructions 408 may be implemented via hardware, firmware, software, and/or combinations thereof.

In operation, the data processor 400 receives capacitance levels from the continuous sensor plate 412, the wet reference sensor 414, the continuous compensating reference plate 418, and the dry reference sensor 416. These capacitance levels are converted to digital values by the capacitance to digital converter 304 for use by the I/O module 402. These digital values are eventually processed according to computer readable instructions 408 via the processor 406. Additionally, the processor 400 receives the total resistance value from the series of components when powered up and this informs the final length of the sensor. For example, calculations of length based on the total resistance value from the series of components would be included as part of the embedded firmware (e.g., where one ohm might correspond to one inch in length while five ohms might correspond to one inch in length, etc.). Accordingly, there would be a resistance value per unit length programmed into the firmware in such an example.

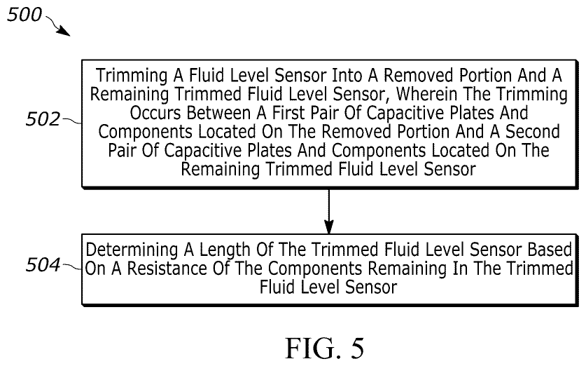

FIG. 5 is a flowchart of an example of a method 500 for fluid level sensing according to an example. The method 500 may generally be implemented in an apparatus, such as, for example, the flexible housing 100 (FIG. 1) and/or the fluid level sensor 200 (FIG. 2), already discussed.

In an example, the method 500 can be implemented in computer readable instructions (e.g., software), configurable computer readable instructions (e.g., firmware), fixed-functionality computer readable instructions (e.g., hardware), etc., or any combination thereof.

It will be appreciated that some or all of the operations the method 500 are described using a “pull” architecture (e.g., polling for new information followed by a corresponding response) can instead be implemented using a “push” architecture (e.g., sending such information when there is new information to report), and vice versa.

Illustrated processing block 502 provides for trimming a fluid level sensor. For example, a fluid level sensor is trimmed into a removed portion and a remaining trimmed fluid level sensor. In such an example, the trimming occurs between a first pair of capacitive plates and components located on the removed portion and a second pair of capacitive plates and components located on the remaining trimmed fluid level sensor.

In some implementations, the trimming occurs at an indicator located on a flexible housing, where the indicator is located between the first pair of capacitive plates and components located on the removed portion and the second pair of capacitive plates and components located on the remaining trimmed fluid level sensor.

In some examples, method 500 further includes sealing the fluid level sensor at the location where the fluid level sensor was trimmed.

Illustrated processing block 502 provides for determining a length of the trimmed fluid level sensor. For example, a length of the trimmed fluid level sensor is determined based on a measured series resistance of the components remaining in the trimmed fluid level sensor.

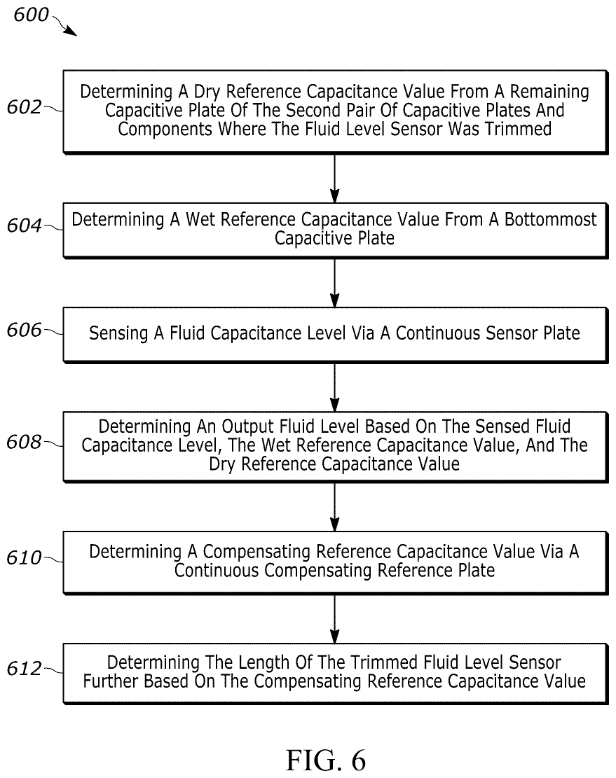

Additional, or alternative details of method 500 are described below with respect to FIG. 6.

FIG. 6 is a flowchart of another example of a method 600 for fluid level sensing according to an example. The method 600 may generally be implemented in an apparatus, such as, for example, the flexible housing 100 (FIG. 1) and/or the fluid level sensor 200 (FIG. 2), already discussed.

In an example, the method 600 can be implemented in computer readable instructions (e.g., software), configurable computer readable instructions (e.g., firmware), fixed-functionality computer readable instructions (e.g., hardware), etc., or any combination thereof.

It will be appreciated that some or all of the operations the method 600 are described using a “pull” architecture (e.g., polling for new information followed by a corresponding response) can instead be implemented using a “push” architecture (e.g., sending such information when there is new information to report), and vice versa.

Illustrated processing block 602 provides for determining a dry reference value. For example, a dry reference value is determined from a remaining capacitive plate of the second pair of capacitive plates and components where the fluid level sensor was trimmed.

Illustrated processing block 604 provides for determining a wet reference value. For example, a wet reference value is determined from a bottommost capacitive plate.

Illustrated processing block 606 provides for sensing a fluid level. For example, a fluid level is sensed via a continuous sensor plate.

Illustrated processing block 608 provides for determining an output fluid level. For example, an output fluid level is determined based on the sensed fluid capacitance value, the wet reference capacitance value, and the dry reference capacitance value.

Illustrated processing block 610 provides for determining a compensating reference capacitance value. For example, a compensating reference capacitance value is determined via a continuous compensating reference plate.

Illustrated processing block 612 provides for determining the length of the trimmed fluid level sensor further based on the compensating reference capacitance value.

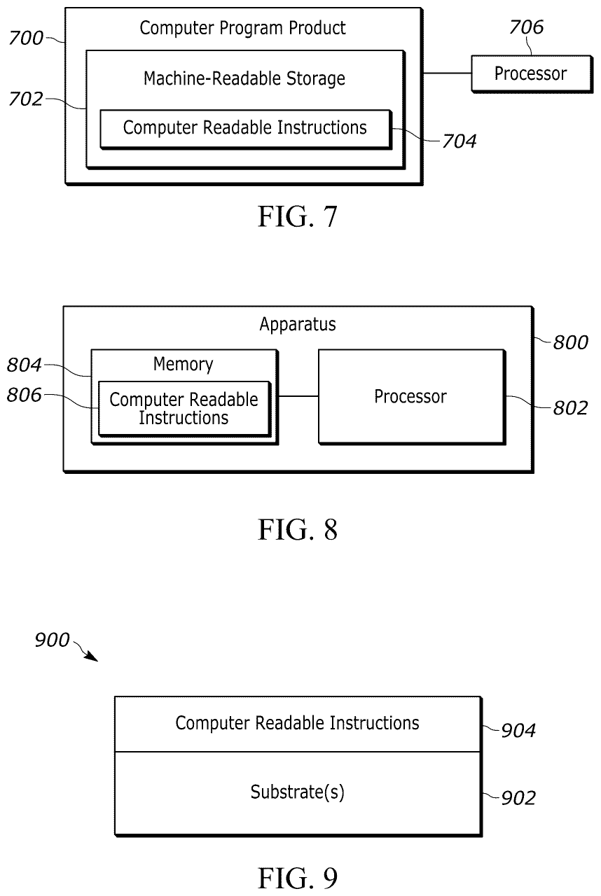

FIG. 7 illustrates a block diagram of an example computer program product 700. In some examples, as shown in FIG. 7, computer program product 700 includes a machine-readable storage 702 that can also include computer readable instructions 704. In some implementations, the machine-readable storage 702 can be implemented as a non-transitory machine-readable storage. In some implementations the computer readable instructions 704, which can be implemented as software, for example. In an example, the computer readable instructions 704, when executed by a processor 706, implement one or more aspects of the method 500 (FIG. 5) and/or method 600 (FIG. 6), already discussed.

FIG. 8 shows an illustrative example of an apparatus 800. In the illustrated example, the apparatus 800 can include a processor 802 and a memory 804 communicatively coupled to the processor 802. The memory 804 can include computer readable instructions 806, which can be implemented as software, for example. In an example, the computer readable instructions 806, when executed by the processor 802, implement one or more aspects of the method 500 (FIG. 5) and/or method 600 (FIG. 6), already discussed.

In some implementations, the processor 802 can include a general purpose controller, a special purpose controller, a storage controller, a storage manager, a memory controller, a micro-controller, a general purpose processor, a special purpose processor, a central processor unit (CPU), the like, and/or combinations thereof.

Further, implementations can include distributed processing, component/object distributed processing, parallel processing, the like, and/or combinations thereof. For example, virtual computer system processing can implement one or more of the methods or functionalities as described herein, and the processor 802 described herein can be used to support such virtual processing.

In some examples, the memory 804 is an example of a computer-readable storage medium. For example, memory 804 can be any memory which is accessible to the processor 802, including, but not limited to RAM memory, registers, and register files, the like, and/or combinations thereof. References to “computer memory” or “memory” should be interpreted as possibly being multiple memories. The memory can for instance be multiple memories within the same computer system. The memory can also be multiple memories distributed amongst multiple computer systems or computing devices.

FIG. 9 shows an illustrative semiconductor apparatus 900 (e.g., chip and/or package). The illustrated apparatus 900 includes one or more substrates 902 (e.g., silicon, sapphire, or gallium arsenide) and computer readable instructions 904 (such as, configurable computer readable instructions (e.g., firmware) and/or fixed-functionality computer readable instructions (e.g., hardware)) coupled to the substrate(s) 902. In an example, the computer readable instructions 904 implement one or more aspects of the method 500 (FIG. 5) and/or method 600 (FIG. 6), already discussed.

In some implementations, computer readable instructions 904 can include transistor array and/or other integrated circuit (IC) components. For example, configurable firmware logic and/or fixed-functionality hardware logic implementations of the computer readable instructions 904 can include configurable computer readable instructions such as, for example, programmable logic arrays (PLAs), field programmable gate arrays (FPGAs), complex programmable logic devices (CPLDs), or fixed-functionality computer readable instructions (e.g., hardware) using circuit technology such as, for example, application specific integrated circuit (ASIC), complementary metal oxide semiconductor (CMOS) or transistor-transistor logic (TTL) technology, the like, and/or combinations thereof.

### Additional Notes and Examples

Clause 1 is a fluid level sensor, comprising: a flexible substrate; a continuous sensor plate coupled to the flexible substrate; a continuous ground plate coupled to the flexible substrate and positioned parallel to the continuous sensor plate; a sensor array positioned parallel to the continuous sensor plate, wherein the sensor array comprises three or more capacitive plates in a linear alignment; and a component array positioned parallel to the continuous sensor plate, wherein the component array comprises three or more components in a linear alignment, wherein each of the components corresponds with one of the capacitive plates.

Clause 2 includes the fluid level sensor of Clause 1, wherein the fluid level sensor is adapted to be trimmed into a removed portion and a remaining trimmed fluid level sensor.

Clause 3 includes the fluid level sensor of Clause 2, further comprising: a flexible housing encompassing the flexible substrate; and a trimmable indicator located on the flexible housing, wherein the trimmable indicator is located between a first pair of the capacitive plates and the components and a second pair of the capacitive plates and the components.

Clause 4 includes the fluid level sensor of any one of Clauses 1 to 3, further comprising a continuous compensating reference plate positioned parallel to the continuous sensor plate, wherein the continuous compensating reference plate is to determine a compensating reference value based on the presence the capacitive plates.

Clause 5 includes the fluid level sensor of any one of Clauses 1 to 4, further comprising a shielding layer located on an outer surface of the flexible substrate that is opposite an inner surface of the flexible substrate where the continuous sensor plate is located, and wherein the shielding layer is composed of copper.

Clause 6 includes the fluid level sensor of Clause 5, further comprising a capacitance to digital converter located on the outer surface of the flexible substrate in a gap formed in the shielding layer.

Clause 7 includes the fluid level sensor of any one of Clauses 1 to 6, wherein the flexible substrate is a printed circuit board.

Clause 8 includes the fluid level sensor of any one of Clauses 1 to 7, wherein the continuous sensor plate has an elongated linear shape running from an upper end of the flexible substrate to a lower end of the flexible substrate, and wherein the continuous sensor plate is composed of copper; wherein the continuous ground plate has an elongated linear shape running from the upper end of the flexible substrate to the lower end of the flexible substrate, and wherein the continuous ground plate is composed of copper; and wherein the capacitive plates are composed of copper.

Clause 9 includes the fluid level sensor of any one of Clauses 1 to 8, wherein each of the components comprise is a discrete resistor.

Clause 10 includes the fluid level sensor of any one of Clauses 1 to 9, wherein each of the capacitive plates has a dedicated trace; wherein a top plate of the capacitive plates comprises a dry reference sensor; and wherein a bottom plate of the capacitive plates comprises a wet reference sensor.

Clause 11 includes a method comprising: trimming a fluid level sensor into a removed portion and a remaining trimmed fluid level sensor, wherein the trimming occurs between a first pair of capacitive plates and components located on the removed portion and a second pair of capacitive plates and components located on the remaining trimmed fluid level sensor; and determining a length of the trimmed fluid level sensor based on a resistance of the components remaining in the trimmed fluid level sensor.

Clause 12 includes the method of Clause 11, wherein the trimming occurs at an indicator located on a flexible housing, and wherein the indicator is located between the first pair of capacitive plates and components located on the removed portion and the second pair of capacitive plates and components located on the remaining trimmed fluid level sensor.

Clause 13 includes the method of any one of Clauses 11 to 12, further comprising sealing the fluid level sensor at the location where the fluid level sensor was trimmed.

Clause 14 includes the method of any one of Clauses 11 to 13, further comprising determining a dry reference capacitance value from a remaining capacitive plate of the second pair of capacitive plates and components where the fluid level sensor was trimmed.

Clause 15 includes the method of Clause 14, further comprising determining a wet reference capacitance value from a bottommost capacitive plate.

Clause 16 includes the method of Clause 15, further comprising sensing a fluid capacitance level via a continuous sensor plate.

Clause 17 includes the method of Clause 16, further comprising determining an output fluid level based on the sensed fluid capacitance level, the wet reference capacitance value, and the dry reference capacitance value.

Clause 18 includes the method of Clause 17, further comprising: determining a compensating reference capacitance value via a continuous compensating reference plate; and determining the length of the trimmed fluid level sensor further based on the compensating reference capacitance value.

Clause 19 includes the fluid level sensor, comprising: a substrate; a continuous sensor plate coupled to the substrate; a continuous ground plate coupled to the substrate and positioned parallel to the continuous sensor plate; a sensor array positioned parallel to the continuous sensor plate, wherein the sensor array comprises three or more capacitive plates in a linear alignment; and a component array positioned parallel to the continuous sensor plate, wherein the component array comprises three or more components in a linear alignment, wherein each of the components corresponds with one of the capacitive plates.

Clause 20 includes the fluid level sensor of Clause 19, wherein the fluid level sensor is adapted to be trimmed into a removed portion and a remaining trimmed fluid level sensor.

Clause 21 includes a machine-readable storage including machine-readable instructions, which when executed, implement a method or realize an apparatus as claimed in any preceding Clause.

Clause 22 includes an apparatus including means for performing the function of any preceding Clause.

All definitions, as defined and used herein, should be understood to control over dictionary definitions, definitions in documents incorporated by reference, and/or ordinary meanings of the defined terms.

Furthermore, for ease of understanding, certain functional blocks can have been delineated as separate blocks; however, these separately delineated blocks should not necessarily be construed as being in the order in which they are discussed or otherwise presented herein. For example, some blocks can be able to be performed in an alternative ordering, simultaneously, etc.

As used herein, phrases substantially similar to “at least one of A, B or C” are intended to be interpreted in the disjunctive, i.e., to require A or B or C or any combination thereof unless stated or implied by context otherwise. Further, phrases substantially similar to “at least one of A, B and C” are intended to be interpreted in the conjunctive, i.e., to require at least one of A, at least one of B and at least one of C unless stated or implied by context otherwise. Further still, the term “substantially” or similar words requiring subjective comparison are intended to mean “within manufacturing tolerances” unless stated or implied by context otherwise.

As used herein, the terms “coupled,” “attached,” “connected,” or “operatively connected” can be used herein to refer to any type of relationship, direct or indirect, between the components in question. For example, the terms “coupled,” “attached,” “connected,” or “operatively connected” may refer to at least a functional relationship between two elements and may encompass configurations in which the two elements are directed connected to each other, i.e., without any intervening elements, or indirectly connected to each other, i.e., with intervening elements. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action can occur, either in a direct or indirect manner.

Although a number of illustrative examples are described herein, it should be understood that numerous other modifications and examples can be devised by those skilled in the art that will fall within the spirit and scope of the principles of the foregoing disclosure. More particularly, reasonable variations and modifications are possible in the component parts and/or arrangements of the subject combination arrangement within the scope of the foregoing disclosure, the drawings and the appended claims without departing from the spirit of the foregoing disclosure. In addition to variations and modifications in the component parts and/or arrangements, alternative uses will also be apparent to those skilled in the art. The examples can be combined to form additional examples.

What is claimed is:

1. A fluid level sensor, comprising:
a flexible substrate;
a continuous sensor plate coupled to the flexible substrate;
a continuous ground plate coupled to the flexible substrate and positioned parallel to the continuous sensor plate;
a sensor array positioned parallel to the continuous sensor plate, wherein the sensor array comprises three or more capacitive plates in a linear alignment; and
a component array positioned parallel to the continuous sensor plate, wherein the component array comprises three or more components in a linear alignment, wherein each of the components corresponds with one of the capacitive plates.

2. The fluid level sensor of claim 1, wherein the fluid level sensor is adapted to be trimmed into a removed portion and a remaining trimmed fluid level sensor.

3. The fluid level sensor of claim 2, further comprising:
a flexible housing encompassing the flexible substrate; and
a trimmable indicator located on the flexible housing, wherein the trimmable indicator is located between a first pair of the capacitive plates and the components and a second pair of the capacitive plates and the components.

4. The fluid level sensor of claim 1, further comprising a continuous compensating reference plate positioned parallel to the continuous sensor plate, wherein the continuous compensating reference plate is to determine a compensating reference value based on the presence the capacitive plates.

5. The fluid level sensor of claim 1, further comprising a shielding layer located on an outer surface of the flexible substrate that is opposite an inner surface of the flexible substrate where the continuous sensor plate is located, and wherein the shielding layer is composed of copper.

6. The fluid level sensor of claim 5, further comprising a capacitance to digital converter located on the outer surface of the flexible substrate in a gap formed in the shielding layer.

7. The fluid level sensor of claim 1, wherein the flexible substrate is a printed circuit board.

8. The fluid level sensor of claim 1,
wherein the continuous sensor plate has an elongated linear shape running from an upper end of the flexible substrate to a lower end of the flexible substrate, and wherein the continuous sensor plate is composed of copper;
wherein the continuous ground plate has an elongated linear shape running from the upper end of the flexible substrate to the lower end of the flexible substrate, and wherein the continuous ground plate is composed of copper; and
wherein the capacitive plates are composed of copper.

9. The fluid level sensor of claim 1, wherein each of the components is a discrete resistor.

10. The fluid level sensor of claim 1,
wherein each of the capacitive plates has a dedicated trace;
wherein a top plate of the capacitive plates comprises a dry reference sensor; and
wherein a bottom plate of the capacitive plates comprises a wet reference sensor.

11. A method comprising:
trimming a fluid level sensor into a removed portion and a remaining trimmed fluid level sensor, wherein the trimming occurs between a first pair of capacitive plates and components located on the removed portion and a second pair of capacitive plates and components located on the remaining trimmed fluid level sensor; and
determining a length of the trimmed fluid level sensor based on a resistance of the components remaining in the trimmed fluid level sensor.

12. The method of claim 11, wherein the trimming occurs at an indicator located on a flexible housing, and wherein the indicator is located between the first pair of capacitive plates and components located on the removed portion and the second pair of capacitive plates and components located on the remaining trimmed fluid level sensor.

13. The method of claim 11, further comprising sealing the fluid level sensor at the location where the fluid level sensor was trimmed.

14. The method of claim 11, further comprising determining a dry reference capacitance value from a remaining capacitive plate of the second pair of capacitive plates and components where the fluid level sensor was trimmed.

15. The method of claim 14, further comprising determining a wet reference capacitance value from a bottommost capacitive plate.

16. The method of claim 15, further comprising sensing a fluid capacitance level via a continuous sensor plate.

17. The method of claim 16, further comprising determining an output fluid level based on the sensed fluid capacitance level, the wet reference capacitance value, and the dry reference capacitance value.

18. The method of claim 17, further comprising:
determining a compensating reference capacitance value via a continuous compensating reference plate; and
determining the length of the trimmed fluid level sensor further based on the compensating reference capacitance value.

19. A fluid level sensor, comprising:
a substrate;
a continuous sensor plate coupled to the substrate;
a continuous ground plate coupled to the substrate and positioned parallel to the continuous sensor plate;
a sensor array positioned parallel to the continuous sensor plate, wherein the sensor array comprises three or more capacitive plates in a linear alignment; and
a component array positioned parallel to the continuous sensor plate, wherein the component array comprises three or more components in a linear alignment, wherein each of the components corresponds with one of the capacitive plates.

20. The fluid level sensor of claim 19, wherein the fluid level sensor is adapted to be trimmed into a removed portion and a remaining trimmed fluid level sensor.
